(19) United States
(12) Patent Application Publication
(10) Pub. No.: US 2026/0184222 A1
(43) Pub. Date: Jul. 2, 2026

(54) CHARGING SYSTEM

(71) Applicant: SUBARU CORPORATION, Tokyo (JP)

(72) Inventor: Kazu HAMADA, Tokyo (JP)

(21) Appl. No.: 18/867,966

(22) PCT Filed: Jul. 5, 2023
(86) PCT No.: PCT/JP2023/025041

§ 371 Date: Nov. 21, 2024

(51) Int. Cl. B60L 53/66; B60L 53/10; B60L 53/67; B60L 53/68

(52) U.S. Cl. CPC B60L 53/66; B60L 53/11; B60L 53/67; B60L 53/68; B60L 2240/72; B60L 2240/80; B60L 2260/50

(57) ABSTRACT

A charging system includes a controller, a charging station configured to be able to charge a vehicle, a first vehicle, and a second vehicle. The controller includes a processor and a memory coupled to the processor. The processor is configured to perform a process including: receiving a reservation for charging of the first vehicle at the charging station; deriving an estimated arrival time of the first vehicle at the charging station, based on a current location and a velocity of the first vehicle; and, when the estimated arrival time is later than a reserved start time of the charging of the first vehicle, allowing charging of the second vehicle at the charging station during a part of a period or an entire period from the reserved start time to the estimated arrival time.

### TECHNICAL FIELD

The present invention relates to a charging system in which charging is performed.

### BACKGROUND ART

For example, PTL 1 discloses a technique for forecasting a possibility that a vehicle will be charged at a charging station. In PTL 1, the lower a remaining battery level of the vehicle is, the higher the charging possibility is forecasted to be, and the higher the remaining battery level is, the lower the charging possibility is forecasted to be.

### CITATION LIST

### Patent Literature

PTL 1: Japanese Unexamined Patent Application Publication No. 2011-13893

### SUMMARY OF INVENTION

### Technical Problem

There are cases in which a vehicle such as an electric vehicle having an electric motor as a drive source attempts to charge an in-vehicle battery at a charging station. However, when the vehicle attempts charging at a charging station at which a reservation for charging can be made in advance, reservations may already be full with other vehicles. In this case, even when an SOC (State Of Charge) of the vehicle is low, there is a possibility that a charging period of the vehicle is not able to be secured.

An object of the present invention is to provide a charging system capable of securing the charging period of the vehicle.

### Solution to Problem

In order to solve the above problem, a charging system according to an embodiment of the present invention includes:
a controller;
a charging station configured to charge a vehicle;
a first vehicle; and
a second vehicle, wherein
the controller includes:
a processor; and
a memory coupled to the processor, and
the processor is configured to perform a process including:
receiving a reservation for charging of the first vehicle at the charging station;
deriving an estimated arrival time of the first vehicle at the charging station, based on a current location and a velocity of the first vehicle; and
when the estimated arrival time is later than a reserved start time of the charging of the first vehicle, allowing charging of the second vehicle at the charging station during a part of a period or an entire period from the reserved start time to the estimated arrival time.

### Advantageous Effects of Invention

According to the present invention, it is possible to secure the charging period of the vehicle.

### BRIEF DESCRIPTION OF DRAWINGS

FIG. 1 is a diagram illustrating an overview of a charging system according to the present embodiment.

FIG. 2 is a block diagram illustrating an example of configurations of a vehicle, a charging station, and a server apparatus constituting the charging system.

FIG. 3 is a diagram illustrating an example of reservation for charging of the vehicle.

FIG. 4 is a diagram illustrating an example of reservation for charging of the vehicle.

FIG. 5 is a diagram for illustrating an example of interruption charging of the vehicle.

FIG. 6 is a diagram for illustrating an example of interruption charging of the vehicle.

FIG. 7 is a diagram for illustrating an example of interruption charging of the vehicle.

FIG. 8 is a diagram for illustrating an example of interruption charging of the vehicle.

FIG. 9 is a diagram for illustrating an example of interruption charging of the vehicle.

FIG. 10 is a flowchart illustrating a flow of a charging method of the vehicle in the charging system.

FIG. 11 is a diagram illustrating a display example of a navigation device in the vehicle.

### DESCRIPTION OF EMBODIMENTS

Hereinafter, an embodiment of the present invention will be described in detail with reference to the accompanying drawings. Specific dimensions, materials, numerical values, and the like illustrated in the embodiment are merely examples for facilitating understanding of the invention, and do not limit the present invention unless otherwise specified. In this specification and the drawings, elements having substantially the same functions and configurations are denoted by the same reference numerals to omit redundant description, and elements not directly related to the present invention are not illustrated.

### (Charging System 1)

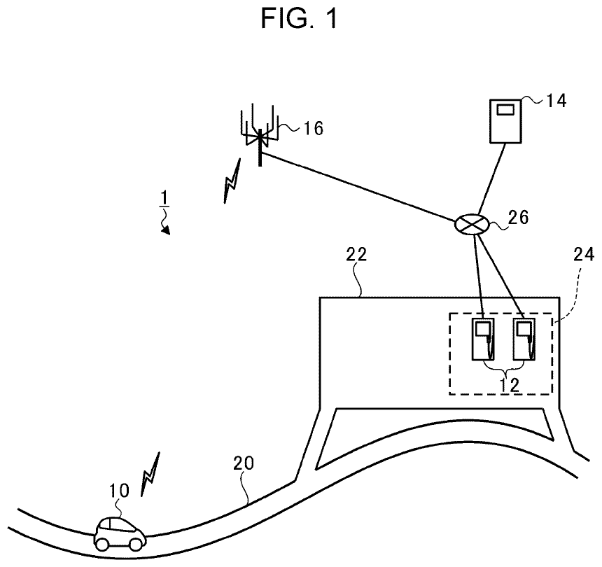

FIG. 1 is a diagram illustrating an overview of a charging system 1 according to the present embodiment. The charging system 1 includes a vehicle 10, a charging station 12, a server apparatus 14, and a base station 16. The vehicle 10 is an electric vehicle having an in-vehicle battery that supplies electric power to a drive source. Note that the vehicle 10 may be a hybrid electric vehicle.

As will be described in detail later, the charging station 12 is configured to be able to charge the in-vehicle battery of the vehicle 10. Hereinafter, charging of the in-vehicle battery may be simply referred to as charging. The term “charging of the vehicle 10” therefore refers to the charging of the in-vehicle battery of the vehicle 10.

The charging station 12 is installed, for example, to correspond to a predetermined position on a travel road 20. In FIG. 1, an example will be described in which the charging station 12 is installed in a rest area 22 on an expressway as the travel road 20. Herein, an expressway is given as the travel road 20, but the present invention is not limited to such a case, and can be applied to various roads on which the vehicle 10 can travel.

Herein, an example is given in which two charging stations 12 are installed in the rest area 22, but the number of charging stations 12 is not limited to two, and may be one, or three or more. Herein, an area in which the charging station 12 is installed and the vehicle 10 is allowed to enter for the purpose of charging is referred to as a charging area 24.

The server apparatus 14 is, for example, a cloud server or the like, and can manage charging stations 12.

The base station 16 communicates with the vehicle 10 via, for example, a mobile communication system using 4G, 5G, or the like. However, the base station 16 is connected to the vehicle 10 via any wireless communication.

Therefore, as a wireless communication system, for example, a communication system such as ITS (Intelligent Transport Systems), ETC (Electronic Toll Collection System), or VICS (Vehicle Information and Communication System) (registered trademark) can be adopted.

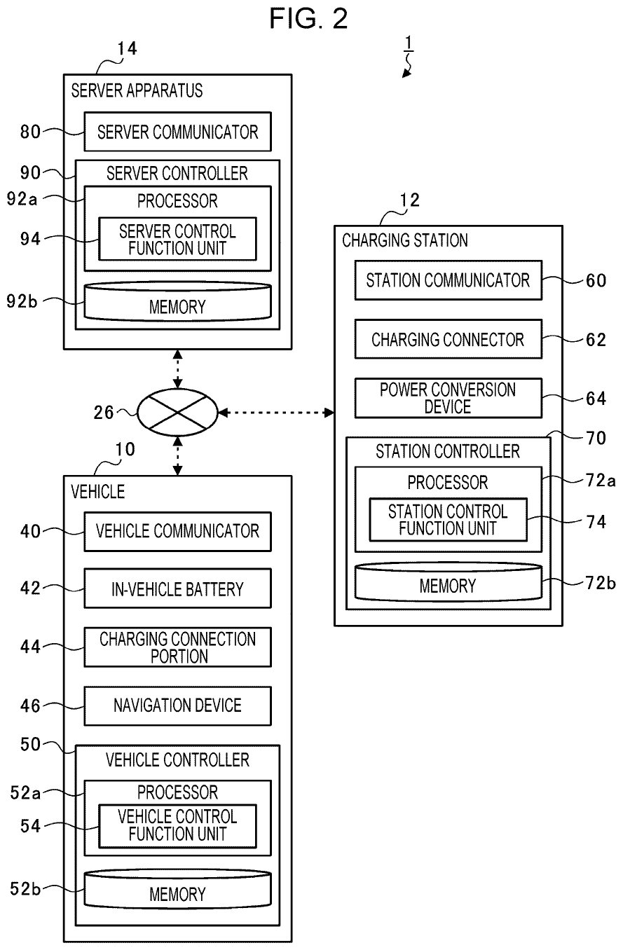

FIG. 2 is a block diagram illustrating an example of configurations of the vehicle 10, the charging station 12, and the server apparatus 14 constituting the charging system 1. The vehicle 10, the charging station 12, and the server apparatus 14 are configured to be able to communicate with each other via, for example, a communication network 26.

The vehicle 10 includes a vehicle communicator 40, an in-vehicle battery 42, a charging connecting portion 44, a navigation device 46, and a vehicle controller 50. The vehicle communicator 40 can establish communication with the charging station 12 and the server apparatus 14 through the communication network 26.

The in-vehicle battery 42 is, for example, a chargeable/dischargeable secondary battery such as a lithium ion battery. The charging connecting portion 44 has a charging port exposed to the outside, and is configured such that a charging connector 62 of the charging station 12, which will be described later, can be connected thereto. The charging connecting portion 44 serves as a connecting portion that electrically connects the charging station 12 and the in-vehicle battery 42.

The navigation device 46 can identify the location of the vehicle 10 by using a GPS (Global Positioning System). The navigation device 46 includes a display device capable of displaying various kinds of information such as map information, a traveling route, and the location of the vehicle 10. The map information may include information on the travel road 20 and information on the installation position of the charging station 12.

The navigation device 46 also serves as a notifier that notifies an occupant of information related to the vehicle 10 and as an operation member that receives the occupant's operation. For example, the navigation device 46 can display information related to the charging of the vehicle 10 on the display device in addition to or instead of the above kinds of information. In addition, the navigation device 46 can receive the occupant's operation input with respect to an option regarding the charging of the vehicle 10 through, for example, a touch panel or the like provided in the navigation device 46.

The vehicle controller 50 includes one or more processors 52a and one or more memories 52b coupled to the processor 52a. The memory 52b includes a ROM in which a program and the like are stored and a RAM as a work area. The processor 52a controls the entirety of the vehicle 10 in cooperation with the program included in the memory 52b. The processor 52a also serves as a vehicle control function unit 54 by executing the program. The vehicle control function unit 54 executes various processes related to the charging of the vehicle 10.

The charging station 12 includes a station communicator 60, the charging connector 62, a power conversion device 64, and a station controller 70. The station communicator 60 can establish communication with the server apparatus 14 and the vehicle 10 through the communication network 26.

The charging connector 62 is configured to be connectable to the charging connecting portion 44 of the vehicle 10. For example, the power conversion device 64 converts electric power of a commercial power supply and supplies the electric power to the vehicle 10 through the charging connector 62 and the charging connecting portion 44. In this way, the in-vehicle battery 42 can be charged.

The station controller 70 includes one or more processors 72a and one or more memories 72b coupled to the processor 72a. The memory 72b includes a ROM in which a program and the like are stored and a RAM as a work area. The processor 72a controls the entirety of the charging station 12 in cooperation with the program included in the memory 72b. The processor 72a also serves as a station control function unit 74 by executing the program. The station control function unit 74 performs various processes related to the charging of the vehicle 10.

The server apparatus 14 includes a server communicator 80 and a server controller 90. The server communicator 80 can establish communication with the charging station 12 and the vehicle 10 through the communication network 26.

The server controller 90 includes one or more processors 92a and one or more memories 92b coupled to the processor 92a. The memory 92b includes a ROM in which a program and the like are stored and a RAM as a work area. The processor 92a controls the entirety of the server apparatus 14 in cooperation with the program included in the memory 92b. The processor 92a also serves as a server control function unit 94 by executing the program. The server control function unit 94 executes various processes related to the charging of the vehicle 10.

A certain vehicle 10 having an electric motor as a drive source, attempts to charge the in-vehicle battery 42 at the charging station 12 as the SOC in the in-vehicle battery 42 decreases. For example, when the certain vehicle 10 is traveling on the travel road 20, the vehicle 10 is considered to stop by the rest area 22 and charge the in-vehicle battery 42 at the charging station 12 in the rest area 22.

However, since the SOC in another vehicle 10 or the timing at which an occupant of the other vehicle 10 attempts charging is unknown, there are cases in which vehicles 10 attempt charging at the same charging station 12. Thus, there are cases in which, even when the certain vehicle 10 arrives at the rest area 22, the in-vehicle battery 42 is not able to be charged immediately.

Herein, charging at some charging stations 12 can be reserved in advance via the server apparatus 14. At a timing when the certain vehicle 10 has not arrived at the rest area 22, for example, when the vehicle 10 is traveling on the travel road 20, the vehicle 10 predicts an arrival time at the charging station 12 and reserves a desired charging period from the arrival time. Note that a start time of the reserved charging may be referred to as a reserved start time, and an end time of the reserved charging may be referred to as a reserved end time. In this way, when the certain vehicle 10 arrives at the charging station 12, the in-vehicle battery 42 can be charged from the reserved start time without waiting for charging.

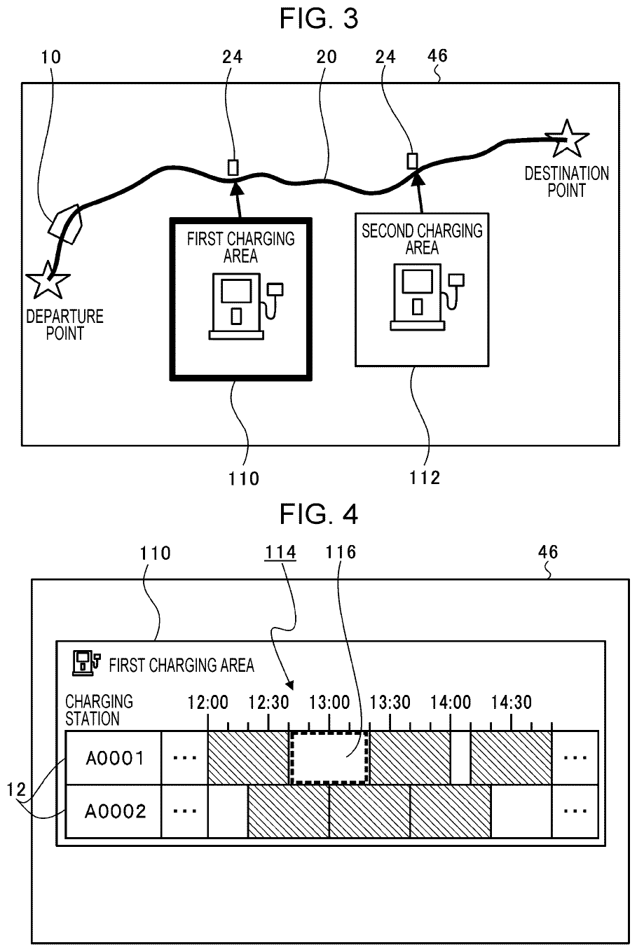

FIGS. 3 and 4 are diagrams illustrating an example of reservation for the charging of the vehicle 10. As the SOC in the in-vehicle battery 42 decreases, an occupant of the certain vehicle 10 attempts to identify, on the travel road 20, the charging station 12 at which charging can be performed.

The navigation device 46 displays a departure point, a destination point, the travel road 20, and a current location of the certain vehicle 10. As illustrated in FIG. 3, the navigation device 46 also displays, for example, an image indicating the position of a first charging area 110 and an image indicating the position of a second charging area 112, which are charging areas 24 reachable with the current SOC. The occupant identifies, for example, the first charging area 110 of the displayed charging areas 24 through the navigation device 46.

The vehicle control function unit 54 establishes communication with the server apparatus 14 via the base station 16, and requests acquisition of a charging schedule corresponding to the identified charging area 24. The charging schedule indicates a reservation status of charging for each of charging stations 12 installed in the charging area 24. The server control function unit 94 of the server apparatus 14 transmits the charging schedule at and after a current time point to the certain vehicle 10.

As illustrated in FIG. 4, the navigation device 46 displays an image indicating a charging schedule 114 received from the server apparatus 14. Through the navigation device 46, the occupant can grasp two charging stations 12 in the first charging area 110 and reservation statuses of charging at the two charging stations 12. In the example in FIG. 4, time slots in which charging is reserved by other vehicles 10 are indicated by hatching on the navigation device 46.

Herein, for example, at a charging station “A0001”, charging is reserved in the time slots of 12:00 to 12:40, 13:20 to 14:00, and 14:10 to 14:50. The occupant can, for example, designate a time slot 116, which is 40 minutes from 12:40 to 13:20, other than the time slots indicated by the hatching in FIG. 4 so as to reserve the time slot 116 as a time slot for charging the occupant's vehicle 10. Thus, the certain vehicle 10 can secure the charging period of 40 minutes from the reserved start time 12:40 to the reserved end time 13:20.

However, there may be cases in which reservations for charging are already full with other vehicles 10 when the certain vehicle 10 attempts charging at such a charging station 12 at which charging can be reserved in advance, and the charging period of the certain vehicle 10 is not able to be secured. Accordingly, in the present embodiment, even in a case where another vehicle 10 has reserved charging at the charging station 12, the charging period of the certain vehicle 10 is secured based on the state of the other vehicle 10 that has reserved charging.

For example, even in a case where the other vehicle 10 has reserved charging in advance, the reserved other vehicle 10 is not always able to start charging at the reserved start time due to congestion or the like. The server control function unit 94 of the server apparatus 14 estimates an actual start time of the charging of the other vehicle 10 that has reserved the start of charging after a timing at which the certain vehicle 10 desires the start of charging. Herein, the time at which the other vehicle 10 arrives at the charging area 24 is regarded as a start time of the charging of the other vehicle 10. Therefore, the server control function unit 94 estimates an actual arrival time of the other vehicle 10. The arrival time that is estimated may be referred to as an estimated arrival time.

When the estimated arrival time that is estimated is later than the reserved start time of charging that is reserved by the other vehicle 10, the server control function unit 94 allows the charging of the certain vehicle 10 until the estimated arrival time of the other vehicle 10 that has reserved charging. Hereinafter, such interruption by the charging of the certain vehicle 10 during the period for which the other vehicle 10 has reserved charging may be referred to as interruption charging.

Herein, for convenience of description, the other vehicle 10 that has reserved charging after the timing at which the certain vehicle 10 desires the start of charging is referred to as a vehicle 10a (first vehicle), and the certain vehicle 10 is referred to as a vehicle 10b (second vehicle). In addition, it is assumed that an actual start time of the charging of the vehicle 10a is substantially equal to an estimated arrival time of the vehicle 10a.

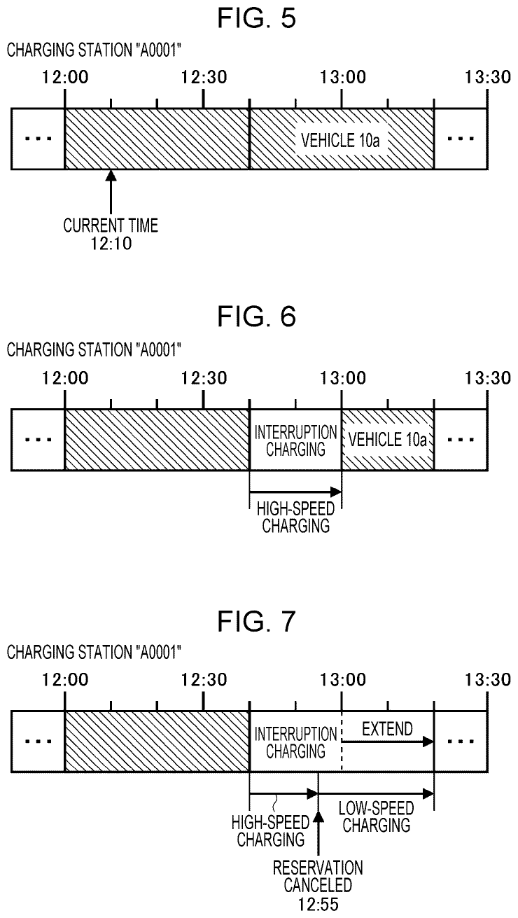

FIGS. 5 to 7 are diagrams for illustrating an example of interruption charging of the vehicle 10b. Herein, an example will be described in which the vehicle 10b performs the interruption charging at the charging station “A0001” in the first charging area 110.

It is assumed that the vehicle 10b desires the charging of the in-vehicle battery 42 at a current time 12:10 near the charging area 24. As for the time after the timing at which the vehicle 10b desires the start of charging, the vehicle 10a has reserved charging between 12:40 and 13:20. As can be understood with reference to FIG. 5, herein, another vehicle 10 has reserved charging for the period during which the vehicle 10b desires charging. At this time, it is assumed that the vehicle 10a has not yet performed a procedure for starting charging, for example, check-in, at the charging station “A0001”.

Herein, an example is described in which the charging of the in-vehicle battery 42 is desired at the current time 12:10 on the assumption that the vehicle 10b is already near the charging area 24. However, the present invention is not limited to such a case, and when the vehicle 10b is still traveling on the travel road 20, an arrival time of the vehicle 10b at the charging area 24 can be adopted as the timing at which the start of charging is desired. In this case, the current time may be considered as the arrival time of the vehicle 10b.

The vehicle control function unit 54 of the vehicle 10b establishes communication with the server apparatus 14 via the base station 16, and requests the interruption charging at the charging station “A0001” in the identified charging area 24. The server control function unit 94 of the server apparatus 14 establishes communication with the vehicle 10a via the base station 16, and grasps the state of the vehicle 10a. The server control function unit 94 can grasp, for example, a current location and an average velocity of the vehicle 10a.

The server control function unit 94 acquires the current location of the vehicle 10a on condition that the vehicle 10a has not performed a procedure for starting charging, and derives a remaining distance d from the current location of the vehicle 10a to the charging station “A0001”. Subsequently, the server control function unit 94 acquires an average velocity Va of the vehicle 10a, and divides the remaining distance d by the average velocity Va to derive a necessary period In to arrive at the charging area 24. Subsequently, the server control function unit 94 adds the necessary period Tn to the current time 12:10 to derive the estimated arrival time of the vehicle 10a. Such an estimated arrival time can substantially be regarded as the actual start time of the charging of the vehicle 10a.

Herein, for example, when the remaining distance d of the vehicle 10a is 10 km and the average velocity Va thereof is 60 km/h, the necessary period Tn is 10 minutes and the estimated arrival time is 12:20. In this way, if the estimated arrival time is before 12:40, the vehicle 10a can start charging at the charging station “A0001” as scheduled. Therefore, the charging schedule illustrated in FIG. 5 proceeds as scheduled, and the interruption charging of the vehicle 10b is not possible. In this case, the server control function unit 94 notifies the vehicle 10b that the interruption charging is not possible.

On the other hand, for example, when the remaining distance d of the vehicle 10a is 50 km and the average velocity Va thereof is 60 km/h, the necessary period Tn is 50 minutes and the estimated arrival time is 13:00. In this way, if the estimated arrival time is 13:00, which is after 12:40, the vehicle 10a is not able to start charging before 13:00. Then, as illustrated in FIG. 6, no vehicle 10 performs charging at the charging station “A0001” between 12:40 and 13:00. The server control function unit 94 notifies the vehicle 10b that the interruption charging can be performed between 12:40 and 13:00.

Then, the vehicle 10b transmits to the server apparatus 14 a notification indicating that the interruption charging is to be performed between 12:40 and 13:00. In this way, the vehicle 10b can perform the interruption charging between 12:40 and 13:00 at the charging station “A0001”.

Note that there are cases where types of output power amount are set at the charging station 12. The charging station 12 can switch and output, for example, two types of output power amount, which are a first output power amount of 6 to 22 kW at single-phase AC 200 V and a second output power amount of 22 to 350 KW at direct current 400 to 500 V larger than the first output power amount.

Herein, since the first output power amount is a small output power amount and the period for charging tends to be long, charging with the first output power amount may be referred to as “low-speed charging” or “normal charging”. On the other hand, since the second output power amount is a large output power amount and can shorten the period for charging, charging with the second output power amount may be referred to as “high-speed charging” or “rapid charging”.

However, the above-described interruption charging of the vehicle 10b is merely charging using an available period due to late arrival of the vehicle 10a. Therefore, in a case of the interruption charging, the charging period of the vehicle 10b is likely to be limited. Accordingly, the server control function unit 94 notifies the vehicle 10b that the interruption charging can be performed between 12:40 and 13:00, and performs control such that the high-speed charging with the second output power amount is performed. At this time, the server control function unit 94 may automatically set the high-speed charging with the second output power amount, or may prompt the vehicle 10b to perform the high-speed charging with the second output power amount and set the high-speed charging with the second output power amount according to the response.

In this way, as illustrated in FIG. 6, the vehicle 10b can perform the high-speed charging with the second output power amount while the interruption charging is being performed. The charging connecting portion 44 of the vehicle 10b is provided with types of charging port, and the occupant can select the output power amount for charging depending on the charging port of the charging connecting portion 44. In this way, the vehicle 10b positively performs the high-speed charging in the interruption charging, so that the SOC in the in-vehicle battery 42 can be efficiently increased in the short-time interruption charging.

Herein, an example has been described in which, when the vehicle 10a arrives later than the reserved start time, the vehicle 10b is allowed to perform the interruption charging before the arrival of the vehicle 10a. However, the vehicle 10a may not be able to arrive at the charging station “A0001” between 12:40 and 13:20, which is the reserved charging period, due to some reasons such as congestion of the travel road 20. Therefore, although the vehicle 10a has reserved charging at the charging station “A0001”, the reservation for charging may be canceled by the end of the reserved period.

In this way, when the reservation for charging by the vehicle 10a is canceled, as illustrated in FIG. 7, no vehicle 10 performs charging at the charging station “A0001” between 13:00 and 13:20. The server control function unit 94 notifies the vehicle 10b that the interruption charging is also possible between 13:00 and 13:20. Thus, as illustrated in FIG. 7, the vehicle 10b can secure a sufficient charging period such as 12:40 to 13:20.

Note that, when the vehicle 10a cancels the reservation for charging, the vehicle 10b can perform the interruption charging over the entire reserved period of the vehicle 10a. Then, since a sufficient period can be secured for charging, it is not necessary to perform the high-speed charging with the second output power amount throughout the interruption charging. Accordingly, the server control function unit 94 switches the high-speed charging with the second output power amount to the low-speed charging with the first output power amount for the vehicle 10b in response to the reservation for the charging of the vehicle 10a being canceled. At this time, the server control function unit 94 may automatically switch from the second output power amount to the first output power amount, or may prompt the vehicle 10b to switch the output power amount and switch from the second output power amount to the first output power amount according to the response.

In this way, as illustrated in FIG. 7, the vehicle 10b can perform the low-speed charging with the first output power amount from 12:55 when the vehicle 10a cancels the reservation while receiving the high-speed charging with the second output power amount. In this way, by using both the high-speed charging and the low-speed charging in the interruption charging, it is possible to obtain advantages of the low-speed charging, for example, the effect of suppressing the deterioration of the in-vehicle battery 42 and the effect of suppressing the charging cost, while efficiently increasing the SOC in the in-vehicle battery 42.

Herein, an example has been described in which the server control function unit 94 estimates the estimated arrival time of the vehicle 10a that has reserved charging, and allocates the period from the reserved start time to the estimated arrival time to the interruption charging of the vehicle 10b. However, the vehicle 10a may increase the velocity and arrive at the charging station “A0001” earlier than the estimated arrival time estimated by the server control function unit 94. Accordingly, the server control function unit 94 may repeat the estimation of the arrival time until the vehicle 10a arrives at the charging station “A0001” or until the reservation for the charging of the vehicle 10a is canceled, and adjust the duration of the interruption charging of the vehicle 10b according to the result.

In addition, in the above description, an example has been described in which, among charging periods of other vehicles 10 that have reserved charging, the charging period of the certain vehicle 10 is secured based on the state of the vehicle 10a that has reserved the start of charging after the timing at which the vehicle 10b desires the start of charging. However, the present invention is not limited to such a case, and the charging period of the certain vehicle 10 may be secured based on the state of the vehicle 10 that has already started charging at the timing at which the vehicle 10b desires the start of charging.

For example, depending on the other vehicle 10, charging may end early even if the reserved charging period has not elapsed. In addition, when the charging period is fixedly determined, depending on the other vehicle 10, the fixed charging period may be unnecessary. In addition, depending on the other vehicle 10, the charging period that is longer than a necessary charging period may be reserved to avoid an insufficient charging period. The server control function unit 94 estimates an end time of the charging of the other vehicle 10 that has reserved charging and has already started charging at the timing at which the vehicle 10b desires the start of charging. Herein, the estimated end time of charging is referred to as an estimated end time.

In a case where an actual end time of charging is later than the reserved end time of the reserved charging, the server control function unit 94 prompts the vehicle 10b to perform charging after the other vehicle 10 that has reserved charging ends the charging.

Herein, for convenience of description, the other vehicle 10 that has already started charging at the timing at which the certain vehicle 10 desires the start of charging is referred to as a vehicle 10c (third vehicle), and the certain vehicle 10 is referred to as the vehicle 10b (second vehicle).

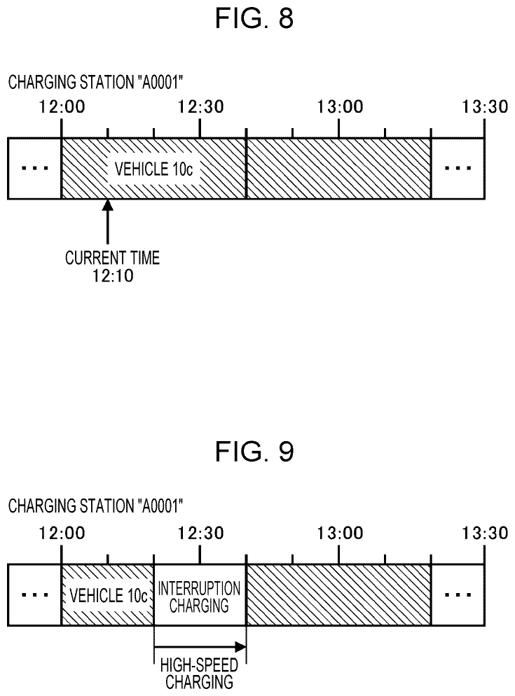

FIGS. 8 and 9 are diagrams for describing an example of the interruption charging of the vehicle 10b. Herein, similarly to FIGS. 5 to 7, an example in which the interruption charging is performed at the charging station “A0001” in the first charging area 110 will also be described. It is assumed that the vehicle 10b desires the charging of the in-vehicle battery 42 at the current time 12:10. For the timing at which the vehicle 10b desires the start of charging, the vehicle 10c reserves charging between 12:00 and 12:40. Note that the vehicle 10c has already performed a procedure for starting charging, for example, check-in, at the charging station “A0001”, and the charging is started.

Herein, an example is described in which the charging of the in-vehicle battery 42 is desired at the current time 12:10 on the assumption that the vehicle 10b is already near the charging area 24. However, the present invention is not limited to such a case, and when the vehicle 10b is still traveling on the travel road 20, the arrival time of the vehicle 10b at the charging area 24 can be adopted as the timing at which the start of charging is desired. In this case, the current time may be considered as the arrival time.

The vehicle control function unit 54 of the vehicle 10b establishes communication with the server apparatus 14 via the base station 16, and requests the interruption charging at the charging station “A0001” in the identified charging area 24. The server control function unit 94 of the server apparatus 14 grasps the state of the vehicle 10c that has reserved charging at the timing at which the vehicle 10b desires the start of charging. The server control function unit 94 can grasp, for example, a past charging history of the vehicle 10c.

Such a charging history may be held in the memory 92b of the server apparatus 14 in association with the vehicle 10c, or may be held in the memory 52b of the vehicle 10c and read by the server control function unit 94 from the memory 52b of the vehicle 10c.

The server control function unit 94 acquires all the charging periods when the vehicle 10c actually performed charging in the past at the charging station “A0001” or the charging station 12 having the same output power amount as the charging station “A0001”. Subsequently, the server control function unit 94 statistically processes the charging periods, and derives an average period Ta and a standard deviation σ thereof. Subsequently, the server control function unit 94 multiplies the standard deviation σ by three and adds the average period Ta to derive a maximum charging period Tm. Herein, the standard deviation σ is multiplied by three because a statistical method is used in which most values of the charging period fall within three standard deviations of the average value. The server control function unit 94 derives the estimated end time by adding the maximum charging period Tm to an actual start time of the charging of the vehicle 10c. Such an estimated end time can be substantially regarded as an actual end time of the charging of the vehicle 10c.

Herein, for example, when the average period Ta of the charging of the vehicle 10c is 30 minutes and the standard deviation σ is 10 minutes, the maximum charging period Tm is 60 minutes and the estimated end time is 13:00. In this way, when the estimated end time is later than 12:40, there is a high possibility that the charging will be continued until 12:40, until which the vehicle 10c has reserved charging at the charging station “A0001”. Therefore, the charging schedule proceeds as illustrated in FIG. 8, and the interruption charging of the vehicle 10b is not possible. In this case, the server control function unit 94 notifies the vehicle 10b that the interruption charging is not possible.

On the other hand, for example, when the average period Ta of the charging of the vehicle 10c is 14 minutes and the standard deviation σ is 2 minutes, the maximum charging period Tm is 20 minutes and the estimated end time is 12:20. In this way, if the estimated end time is earlier than 12:40, which is the reserved end time, there is a high possibility that the vehicle 10c ends the charging before 12:20. Then, as illustrated in FIG. 9, the possibility that no vehicle 10 performs charging at the charging station “A0001” between 12:20 and 12:40 is high. The server control function unit 94 notifies the vehicle 10b that the interruption charging can be performed between 12:20 and 12:40.

Then, the vehicle 10b transmits to the server apparatus 14 a notification indicating that the interruption charging is desired between 12:20 and 12:40. In this way, the vehicle 10b can perform the interruption charging between 12:20 and 12:40 at the charging station “A0001”.

However, the interruption charging of the vehicle 10b is merely charging using an available period due to early end of the charging of the vehicle 10c. Therefore, in a case of the interruption charging, the charging period of the vehicle 10b is likely to be limited. Accordingly, the server control function unit 94 notifies the vehicle 10b that the interruption charging can be performed between 12:20 and 12:40, and performs control such that the high-speed charging with the second output power amount is performed. At this time, the server control function unit 94 may automatically set the high-speed charging with the second output power amount, or may prompt the vehicle 10b to perform the high-speed charging with the second output power amount and set the high-speed charging with the second output power amount according to the response. In this way, as illustrated in FIG. 9, the vehicle 10b can perform the high-speed charging with the second output power amount while the interruption charging is being performed.

Herein, an example has been described in which the server control function unit 94 estimates the estimated end time of the charging of the vehicle 10c that has reserved the charging, and allocates the period from the estimated end time to the reserved end time to the interruption charging of the vehicle 10b. However, there is a possibility that the vehicle 10c performs charging for a long period and continues charging until a time later than the estimated end time estimated by the server control function unit 94. Accordingly, the server control function unit 94 may monitor the charging of the vehicle 10c and adjust the duration of the interruption charging of the vehicle 10b according to the result.

During the charging of the vehicle 10c, the server control function unit 94 may recommend the interruption charging to the vehicle 10b instead of allowing the interruption charging. In this case, the occupant of the vehicle 10b waits for the interruption charging recommended during the charging of the vehicle 10c in a state in which the interruption charging can be performed when the charging of the vehicle 10c ends early.

During the charging of the vehicle 10c, it is not possible for the server control function unit 94 to allow the interruption charging of the vehicle 10b with priority over the vehicle 10c. However, when the vehicle 10b requests the interruption charging before another vehicle 10, the server control function unit 94 may prohibit further interruption of the other vehicle 10, and may allow the interruption charging of the vehicle 10b with priority over the other vehicle 10 in response to the end of the charging of the vehicle 10c.

Herein, an example has been described in which, when the estimated arrival time of the vehicle 10a is later than the reserved start time, or when the estimated end time of the charging of the vehicle 10c is earlier than the reserved end time, the entire available period is allocated to the interruption charging of the vehicle 10b. However, the present invention is not limited to such a case, and a part of the available period may be allocated to the interruption charging of the vehicle 10b.

Herein, an example has been described in which the entire available period is allocated to the interruption charging of the vehicle 10b when the estimated arrival time of the vehicle 10a is later than the reserved start time. In addition, an example has been described in which the available period is allocated to the interruption charging of the vehicle 10b when the estimated end time of the charging of the vehicle 10c is earlier than the reserved end time. However, the present invention is not limited to such a case, and when the estimated arrival time of the vehicle 10a is later than the reserved start time and the estimated end time of the charging of the vehicle 10c is earlier than the reserved end time, the continuous available period may be allocated to the interruption charging of the vehicle 10b.

In addition, in a case where a reservation is not made before the vehicle 10a starts charging, the vehicle 10b may start charging before the reserved start time of the charging of the vehicle 10a, and the interruption charging may be performed by a period corresponding to a delay of the estimated arrival time of the vehicle 10a. In addition, in a case where a reservation is not made after the end of the charging of the vehicle 10c, the vehicle 10b may perform the interruption charging from the estimated end time of the charging of the vehicle 10c and may continuously perform the charging even after the reserved end time of the charging of the vehicle 10c.

Herein, an example has been described in which the vehicle 10b performs the interruption charging at the charging station “A0001” in the first charging area 110. However, the present invention is not limited to such a case. The server control function unit 94 may display, through the navigation device 46, the start time and the charging period at and for which the interruption charging can be performed, for all of the charging areas 24 reachable with the SOC at the time when the vehicle 10b is traveling and one or more charging stations 12 installed in the charging areas 24. The occupant of the vehicle 10b can select a desired charging station 12 from such charging stations 12 and reserve the interruption charging at the charging station 12.

Herein, an example has been described in which the vehicle 10b performs the interruption charging. However, the present invention is not limited to such a case. For example, in a case where charging is desired to be started earlier than the reserved start time reserved by the vehicle 10a, the vehicle 10a may perform the interruption charging from the estimated end time of the charging of the vehicle 10c and may continuously perform the charging also during the reserved period of the vehicle 10a. In addition, for example, in a case where charging is desired even after the reserved end time reserved by the vehicle 10c, the vehicle 10c may continuously perform the charging until the estimated arrival time of the vehicle 10a.

With such a configuration, even in a case where the SOC in the vehicle 10 is low but reservations for charging are full with other vehicles 10, it is possible to secure the charging period of the vehicle 10. Therefore, the convenience of the charging of the vehicle 10 can be improved.

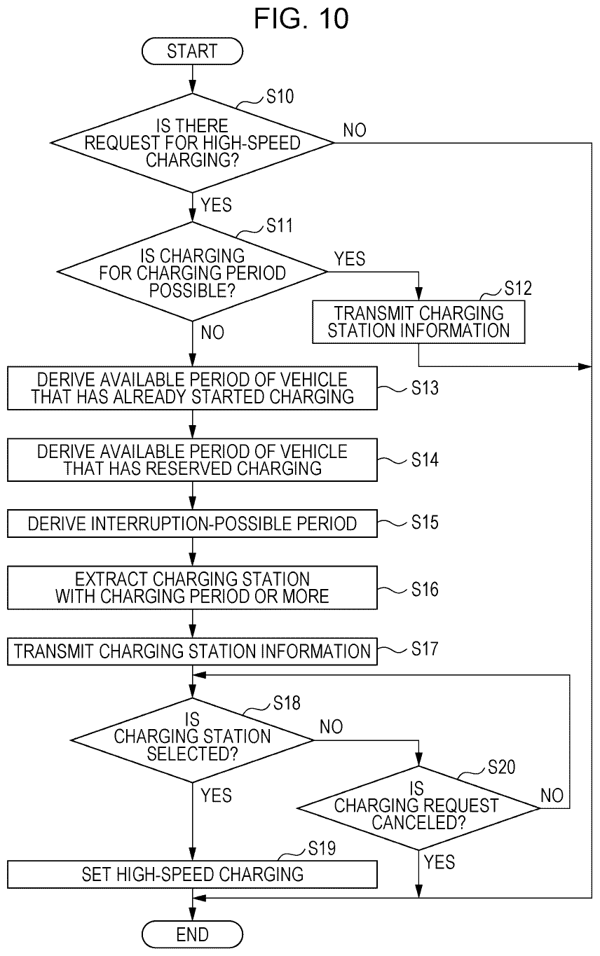

FIG. 10 is a flowchart illustrating a flow of a charging method of the vehicle 10 in the charging system 1.

The server control function unit 94 of the server apparatus 14 establishes communication with the vehicle 10b, and determines whether there is a request for the interruption charging, that is, the high-speed charging with the second output power amount, from the vehicle 10b (S10). If there is no request for the high-speed charging (NO in S10), the server control function unit 94 ends the charging method without performing the interruption charging of the vehicle 10b. When the SOC in the vehicle 10b is less than a predetermined reference value, the vehicle control function unit 54 of the vehicle 10b may determine that the charging amount is not sufficient and may automatically request the high-speed charging.

If there is a request for the high-speed charging (YES in S10), the server control function unit 94 determines whether there is a charging station 12 that allows charging for a predetermined charging period, for example, 30 minutes, in the charging area 24 reachable with the current SOC in the vehicle 10b (S11). That is, it is determined whether there is a charging station 12 that has a continuous available period corresponding to the predetermined charging period. If there is a charging station 12 that allows charging for the predetermined charging period (YES in S11), the server control function unit 94 transmits charging station information to the vehicle 10b through the navigation device 46 (S12). In the charging station information, all the allowing charging stations 12, the start time of charging, and the charging period are associated with each other. Then, the charging method ends.

If there is no charging station 12 that allows charging for the predetermined charging period (NO in S11), the server control function unit 94 derives an available period after the estimated end time of the charging of the vehicle 10c that has already started charging at each charging station 12 (S13).

For example, the server control function unit 94 determines whether there is a vehicle 10c that has already started charging at the charging station 12. If there is no vehicle 10c that has already started charging at the charging station 12, the server control function unit 94 sets, as the available period, the period from the arrival time of the vehicle 10b to the reserved start time of the charging of the vehicle 10a that has reserved subsequent charging.

If there is a vehicle 10c that has already started charging at the charging station 12, the server control function unit 94 acquires all charging periods at the charging station 12 from the past charging history of the vehicle 10c, derives the maximum charging period Im from the average period Ta and the standard deviation σ, and adds the maximum charging period Tm to the actual start time of the charging of the vehicle 10c to derive the estimated end time. The period from the estimated end time to the reserved end time is the available period.

Subsequently, the server control function unit 94 derives the available period before the estimated arrival time of the vehicle 10a that has reserved charging at each charging station 12 (S14).

For example, the server control function unit 94 derives the remaining distance d from the current location of the vehicle 10a to the charging station 12. The vehicle 10a has reserved charging after the timing at which the vehicle 10b desires the start of charging. The server control function unit 94 derives the necessary period Tn to arrive at the charging area 24 from the remaining distance d and the average velocity Va of the vehicle 10a, and adds the necessary period Tn to the current time 12:10 to derive the estimated arrival time. When the estimated arrival time is later than the reserved start time, the period from the reserved start time of charging to the estimated arrival time is the available period.

The server control function unit 94 adds the available period in a case where the estimated end time of the charging of the vehicle 10c is early, which is derived in step S13, and the available period in a case where the estimated arrival time of the vehicle 10a is later than the reserved start time, which is derived in step S14. Thus, the server control function unit 94 derives an interruption-possible period during which the interruption charging can be performed (S15).

The server control function unit 94 extracts the charging station 12 at which the interruption-possible period reached to or exceeds a predetermined charging period, for example, 10 minutes, from among all the charging areas 24 and the charging stations 12 reachable with the current SOC in the vehicle 10b (S16). Subsequently, for the extracted charging station 12, the server control function unit 94 transmits to the vehicle 10b the charging station information in which the charging station 12, the start time of the interruption charging, and the interruption-possible charging period are associated with each other (S17).

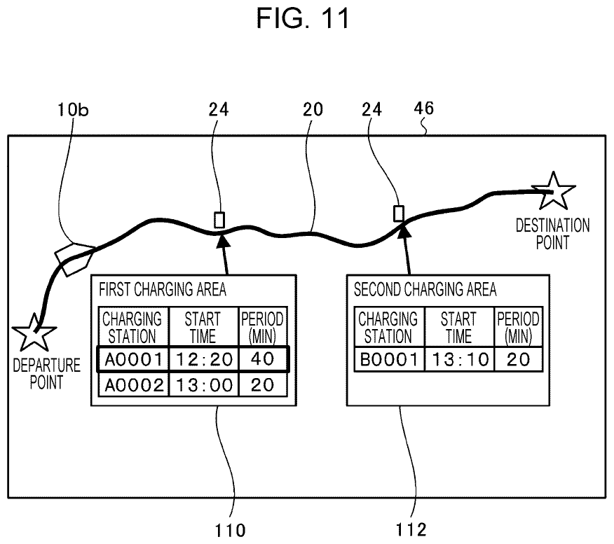

FIG. 11 is a diagram illustrating a display example of the navigation device 46 in the vehicle 10b. As illustrated in FIG. 11, the navigation device 46 displays the charging stations 12 at which the interruption charging can be performed, the start time of the interruption charging, and the interruption-possible charging period in, for example, the first charging area 110 and the second charging area 112, which are the charging areas 24 reachable with the current SOC. The occupant can select one desired charging station 12 from such charging stations 12.

Returning to FIG. 10, the server control function unit 94 determines whether the charging station 12 is selected in the vehicle 10b (S18). If the charging station 12 is selected (YES in S18), the server control function unit 94 sets the high-speed charging with the second output power amount of the vehicle 10b during the available period at such a charging station 12 (S19), and ends the charging method.

If the charging station 12 is not selected (NO in S18), the server control function unit 94 determines whether the charging request is canceled in the vehicle 10b (S20). If the charging request is not canceled (NO in S20), the server control function unit 94 repeats the process from step S18. If the charging request is canceled (YES in S20), the server control function unit 94 ends the charging method.

In the present embodiment, it is possible to secure the charging period of the vehicle 10 even in a case where reservations for charging at the charging station 12 are already full with other vehicles 10. Therefore, the convenience of the charging of the vehicle 10 can be improved.

Although the embodiment of the present invention has been described above with reference to the accompanying drawings, it goes without saying that the present invention is not limited to such an embodiment. It will be apparent to those skilled in the art that various modifications or corrections can be made without departing from the scope described in the claims. It is to be understood that these are naturally included in the technical scope of the present invention.

A series of processes performed by each device (for example, the vehicle 10 or the server apparatus 14) according to the present embodiment described above may be implemented by using any of software, hardware, or a combination of software and hardware. A program constituting the software is stored in advance in, for example, a non-transitory storage medium (non-transitory media) provided inside or outside each device. Then, for example, the program is read from the non-transitory storage medium (for example, a ROM) to a transitory storage medium (for example, a RAM) and executed by a processor such as a CPU.

It is possible to create a program for implementing each function of each device described above and install the program in a computer of each device described above. By the processor executing the program stored in a memory, the processing of each function described above is executed. At this time, the program may be shared and executed by more than one processor, or the program may be executed by one processor. In addition, each function of each device described above may be implemented by cloud computing using computers connected to each other via a communication network. Note that the program may be provided and installed in the computer of each device by being distributed from an external device via a communication network.

### REFERENCE SIGNS LIST

1 charging system
10a vehicle (first vehicle)
10b vehicle (second vehicle)
10c vehicle (third vehicle)
12 charging station
14 server apparatus
42 in-vehicle battery
90 server controller (controller)

1. A charging system comprising:
a controller;
a charging station configured to charge a vehicle;
a first vehicle; and
a second vehicle, wherein
the controller comprises:
a processor; and
a memory coupled to the processor, and
the processor is configured to perform a process comprising:
receiving a reservation for charging of the first vehicle at the charging station;
deriving an estimated arrival time of the first vehicle at the charging station, based on a current location and a velocity of the first vehicle; and
when the estimated arrival time is later than a reserved start time of the charging of the first vehicle, allowing charging of the second vehicle at the charging station during a part of a period or an entire period from the reserved start time to the estimated arrival time.

2. The charging system according to claim 1, wherein
the charging station is configured to switch and output a first output power amount and a second output power amount that is larger than the first output power amount, and
the processor is configured to perform a process comprising
when the estimated arrival time is later than the reserved start time of the charging of the first vehicle, causing the charging station to perform the charging of the second vehicle with the second output power amount during the part of the period or the entire period from the reserved start time to the estimated arrival time.

3. The charging system according to claim 1, wherein the processor is configured to perform a process comprising
when the reservation for the charging of the first vehicle is canceled, allowing the charging of the second vehicle even after the estimated arrival time.

4. The charging system according to claim 1, wherein
the charging station is configured to switch and output a first output power amount and a second output power amount that is larger than the first output power amount, and
the processor is configured to perform a process comprising:
when the estimated arrival time is later than the reserved start time of the charging of the first vehicle, causing the charging station to perform the charging of the second vehicle with the second output power amount during the part of the period or the entire period from the reserved start time to the estimated arrival time; and
when the reservation for the charging of the first vehicle is canceled, allowing the charging of the second vehicle even after the estimated arrival time, and allowing switching from the second output power amount to the first output power amount.

5. A charging system comprising:
a controller;
a charging station configured to charge a vehicle;
a second vehicle; and
a third vehicle, wherein
the controller comprises:
a processor; and
a memory coupled to the processor, and
the processor is configured to perform a process comprising:
receiving a reservation for charging of the third vehicle at the charging station;
deriving an estimated end time at which the charging of the third vehicle ends, based on a past charging history of the third vehicle; and
when the estimated end time is earlier than a reserved end time of the charging of the third vehicle, prompting charging of the second vehicle at the charging station during a part of a period or an entire period from the estimated end time to the reserved end time.
